(19) United States
(12) Patent Application Publication
(10) Pub. No.: US 2007/0033147 A1
(43) Pub. Date: Feb. 8, 2007

(54) Content delivery system and method, content reproduction apparatus and content-providing server, and program for use in the same

(75) Inventor: Toshiaki Kaburagi, Meguro-ku (JP)

Correspondence Address: HARNESS, DICKEY & PIERCE, P.L.C., P.O. BOX 828, BLOOMFIELD HILLS, MI, 48303, US

(73) Assignee: Yamaha Corporation, Hamamatsu-shi (JP)

(21) Appl. No.: 11/499,802

(22) Filed: Aug. 4, 2006

(30) Foreign Application Priority Data
Aug. 4, 2005 (JP) 2005-226572

(51) Int. Cl. G06Q 99/00; H04L 9/00; H04K 1/00

(52) U.S. Cl. 705/59

(57) ABSTRACT

When a plurality of trial-use content are to be successively delivered to a particular user, a content-providing server determines whether a reproducing limitation should be set on the content, on the basis of a sale history for a sale, to the user, of the content, and, in accordance with a result of the determination, the server delivers the content to a content reproduction apparatus with or without a reproducing limitation. Then, the content reproduction apparatus reproduces the delivered content with or without a limitation depending on presence/absence of the reproducing limitation set on the content. For example, trial use of content already purchased by the user is permitted with no reproducing limitation.

### BACKGROUND OF THE INVENTION

The present invention relates to a content delivery system which delivers content via a communication network, content reproduction apparatus and content-providing server constituting the content delivery system and methods for the content delivery system, content reproduction apparatus and content-providing server, as well as programs for the content delivery system, content reproduction apparatus and content-providing server. More particularly, the present invention concerns an improved content selling/providing technique advantageously applicable to successive test-listening of a plurality of items of content.

With the recent development of communication networks, such as the Internet, any interested user can acquire a desired music piece, desired ringer melody or any other desired content that comprises various data, such as picture/image data, at any desired time and at any desired place, by just connecting his or her personal computer terminal or portable communication terminal, such as a portable phone (e.g., cellular phone) or PDA (Personal Data (or Digital) Assistance), to a communication network; thus, the user can enjoy the acquired content by reproducing (i.e., playing back) the content via a user'terminal. Particularly, in recent data delivery services for portable communication terminals, the form or style of content delivery has greatly diversified due to diversified user (customer) needs. For example, when a user wants to acquire and reproduce a desired music piece, it is necessary for the user to personally search for the desired music piece from a multiplicity of music pieces scattered in various data delivery service sites and then purchase the thus searched-out (or found) music piece. For such a purpose, it has been conventional for the user to find a desired music piece by visiting various service sites and searching listings of music pieces supplied by the individual service sites on the basis of, for example, information already known to the user, such as the title of the desired music piece, or by using a so-called test-listening service provided in each site, which allows the user to test-listen to music pieces one by one or in succession (successive test-listening). Examples of content delivery techniques involving such a test-listening service are disclosed in Japanese Patent Application Laid-open Publication Nos. 2001-036423 and 2001-325460.

With the conventionally-known test-listening service, it has been conventional to deliver, to a requesting user, either “test-listening (sample) music piece data” (e.g., data with only some part of the music piece reproducible) provided separately from fully-reproducible “regular music piece data” with all parts reproducible throughout the entire music piece, or limited regular music piece data with some reproducing (or playback) limitation set thereon (e.g., music piece data with a limited or shortened reproducing time), irrespective of whether or not a predetermined purchase procedure has been completed for the music piece in question. After completion of the predetermined purchasing procedure of a desired music piece, the user is allowed to fully reproduce the music piece by the server newly delivering of the regular music piece data or lifting the reproducing limitation. Generally, for each music piece already purchased by the user, the regular music piece data should of course be provided by the server upon a delivery request made by the user. However, with the aforementioned conventional test-listening service, only test-listening (sample) music piece data or limited music piece data with some limitation is always provided even when the music piece requested for a test-listening purpose is one already purchased by the user. Therefore, during test-listening of the music piece, the user can not readily know or identify whether or not the music piece is an already-purchased one, which would result in significant inconveniences.

### SUMMARY OF THE INVENTION

In view of the foregoing, it is an object of the present invention to provide a content delivery system which, during test-listening, allows a user to reproduce desired content with no limitation if the content is one already purchased by the user, a content reproduction apparatus and content-providing server constituting the content delivery system, methods for the content delivery system, content reproduction apparatus and content-providing server, and programs for use in the content delivery system, content reproduction apparatus and content-providing server.

According to a first aspect of the preset invention, there is provided a content delivery system for communicating content between a content reproduction apparatus and a content-providing server interconnected via a communication network. In the content delivery system, the content reproduction apparatus comprises: a section that connects the content reproduction apparatus to the content-providing server for communication therewith via the communication network; a section that receives a list of trial-use (sample) content from the content-providing server; a section that, on the basis of the list, makes a request for requesting the content-providing server to successively deliver a plurality of trial-use (sample) content; a reception section that receives, from the content-providing server, the plurality of trial-use content, sequentially delivered by the content-providing server in response to the request, with or without a reproducing limitation set on each of the content; and a reproduction section that reproduces the content, received by the reception section, with or without a limitation depending on presence/absence of the reproducing limitation set on the content. Further, in the content delivery system, the content-providing server comprises: a section that connects the content-providing server to the content reproduction apparatus for communication therewith via the communication network; a content storage section that stores a plurality of content; a sale history storage section that stores a sale history of each of the content stored in the content storage section, the sale history indicating a history of a sale of the content made to a user of the content reproduction apparatus; a section that supplies a list of trial-use content to the content reproduction apparatus; a readout section that, in response to a request for successive delivery of two or more trial-use content issued by the content reproduction apparatus on the basis of the list, sequentially reads out corresponding content from the content storage section; a section that makes a determination as to whether a reproducing limitation should be set on the content read out by the readout section, on the basis of the sale history stored in the sale history storage section for a sale, to the user of the content reproduction apparatus, of the read-out content; and a section that, in accordance with a result of the determination, delivers the read-out content to the content reproduction apparatus with or without a reproducing limitation.

According to the present invention, in successive delivery of a plurality of test-use (sample) content, the content-providing server makes a determination as to whether a reproducing limitation should be set on the read-out content, on the basis of the sale history, regarding the test-use (sample) content, of the user of the content reproduction apparatus. Then, in accordance with the result of the determination, the content-providing server delivers the content to the content reproduction apparatus with or without a reproducing limitation. In turn, the content reproduction apparatus reproduces the content, delivered from the content-providing server with or without the reproducing function, with or without a limitation depending on presence/absence of the reproducing limitation set on the content. Namely, in the present invention, whether or not a reproducing limitation should be set on the content is controlled in the content-providing server on the basis of the sale history. In this way, the form or style of reproduction can be differentiated between already-purchased content and not-yet-purchased content, which therefore allows the user to readily know or identify whether or not the content currently being test-used is already-purchased content.

Typically, the content is audible content, and trial reproduction performed by the content reproduction apparatus is reproduction for test-listening.

As an example, when the content is to be delivered, the content-providing server attaches, to the content, control data indicating either a setting “with a reproducing limitation” or a setting “with no reproducing limitation”, and delivers, to the content reproduction apparatus, the content with the control data attached thereto. In this case, the content reproduction apparatus reproduces the content with or without a reproducing limitation depending on whether the control data attached to the content received by the reception section indicates the setting “with a reproducing limitation” or the setting “with no reproducing limitation”.

As another example, the content-providing server processes content, which is to be delivered with a reproducing limitation, in such a manner that the content itself has only limited reproducibility and then delivers resultant processed content. When the content received by the reception section itself has only limited reproducibility, the content reproduction apparatus reproduces the received content with a reproducing limitation set thereon.

As an example, the content reproduction apparatus further comprises: a section that transmits, to the content-providing server, a purchase request for purchasing the content currently being reproduced by the reproduction section; and a section that receives and stores content delivered by the content-providing server in response to the purchase request. The content-providing server further comprises: a section that, in response to the purchase request transmitted by the content reproduction apparatus, reads out the content from the content storage section and transmits the read-out content, as sold content, to the content reproduction apparatus with no reproducing limitation; and a section that updates the sale history stored in the sale history storage section for the sold content.

According to a second aspect of the present invention, there is provided a content reproduction apparatus, which comprises: a section that connects the content reproduction apparatus to a content-providing server for communication therewith via a communication network; a section that receives a list of trial-use content from the content-providing server; a section that, on the basis of the list, makes a request for requesting the content-providing server to successively deliver a plurality of trial-use content; a reception section that receives, from the content-providing server, the plurality of trial-use content, sequentially delivered by the content-providing server in response to the request, with or without a reproducing limitation set on each of the content; and a reproduction section that reproduces the content, received by the reception section, with or without a limitation depending on presence/absence of the reproducing limitation set on the content. In this way, the form or style of reproduction can be differentiated between already-purchased content and not-yet-purchased content in the same manner as set forth above, which allows the user to readily identify whether or not the content currently being test-used is already-purchased content.

According to a third aspect of the present invention, there is provided a content-providing server, which comprises: a section that connects the content-providing server to a content reproduction apparatus for communication therewith via a communication network; a content storage section that stores a plurality of content; a sale history storage section that stores a sale history of each of the content stored in the content storage section, the sale history indicating a history of a sale of the content made to a user of the content reproduction apparatus; a section that supplies a list of trial-use content to the content reproduction apparatus; a readout section that, in response to a request for successive delivery of two or more trial-use content issued by the content reproduction apparatus on the basis of the list, sequentially reads out corresponding content from the content storage section; a section that makes a determination as to whether a reproducing limitation should be set on the content read out by the readout section, on the basis of the sale history stored in the sale history storage section for a sale, to the user of the content reproduction apparatus, of the read-out content; and a delivery section that, in accordance with a result of the determination, delivers the read-out content to the content reproduction apparatus with or without a reproducing limitation. In the present invention, the content-providing server makes a determination as to whether a reproducing limitation should be set on the content, on the basis of the content-by-content sale history. Then, in accordance with the result of the determination, the content-providing server delivers the content to the content reproduction apparatus with or without a reproducing limitation. Thus, the user of the content reproduction apparatus, receiving and reproducing the delivered content, is allowed to readily identify whether or not the content currently being test-used is already-purchased content.

The present invention may be constructed and implemented not only as the apparatus invention as discussed above but also as a method invention. Also, the present invention may be arranged and implemented as a software program for execution by a processor such as a computer or DSP, as well as a storage medium storing such a software program. Further, the processor used in the present invention may comprise a dedicated processor with dedicated logic built in hardware, not to mention a computer or other general-purpose type processor capable of running a desired software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the objects and other features of the present invention, its preferred embodiments will be described hereinbelow in greater detail with reference to the accompanying drawings, in which:

FIG. 1 is a block diagram showing an example general setup of a content delivery system in accordance with an embodiment of the present invention;

FIG. 2 are diagrams showing examples of screens displayed in a user terminal, of which a) shows an example of a genre selection screen, (b) shows an example of a genre-specific music piece list screen and (c) shows an example of a music piece reproduction screen;

FIG. 3 is a flow chart showing an example operational sequence of a request receipt process performed in a content-providing server;

FIG. 4 is a flow chart showing an example operational sequence of a request transmission process performed in the user terminal; and

FIG. 5 is a flow chart showing an example operational sequence of a reproduction control process.

### DETAILED DESCRIPTION OF THE INVENTION

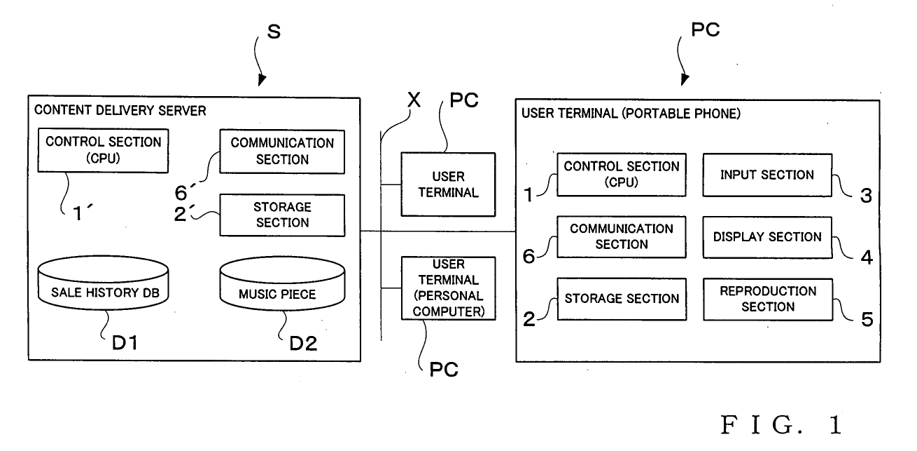

FIG. 1 is a block diagram showing an example general setup of a content delivery system in accordance with an embodiment of the present invention. This content delivery system comprises a content-providing server S that is a content delivery source for providing a data delivery service, and user terminals PC (content reproduction apparatus) that are end users supplied with the data delivery service and capable of playing back or reproducing desired content delivered from the server S. These content-providing server S and the user terminals PC are interconnected via an existing communication network X, such as the Internet, for bidirectional communication. The communication network X, interconnecting the server S and user terminals PC, is not limited to a wired network and may include a wireless network, such as a portable telephone network or satellite communication network. The communication network X may also include a LAN (Local Area Network) in addition to the public telephone network, the Internet, etc. Although the content delivery system of the present invention may include hardware components in addition to those shown in FIG. 1, it will be described hereinbelow in relation to a case where only minimum necessary resources are employed in the system.

The user terminals PC are portable communication terminals, such as portable telephones and PDAs, and personal computer terminals, and users of the user terminals PC can access any desired data delivery site, provided by the content-providing server (hereinafter referred to simply as “server”) S connected to the communication network X, by designating or entering, for example, a unique URL that is a network address comprising predetermined character string information. Namely, once any one of the user terminals PC is connected to the communication network X, the user terminal PC can be placed in a state where it can carry out bidirectional communication with the server S in the communication network X, and then the user terminal PC can access a user-desired data delivery site through entry of the URL and the like and receive user-desired content, such as music piece data (more specifically, a set of music piece data), from the accessed site or transmit various information etc. to the server S. As conventionally known, transmission/reception, i.e. communication, of various information etc. between the user terminal PC and the server S is performed using a predetermined software program, such as an Internet browser. Each of the user terminals PC is capable of reproducing content, such as music piece data. The server S is a server computer having prestored therein a plurality of page description information which pertain to display of site screens for presenting content deliverable from the server S to the user terminals PC and which are described using, for example, an HTML (Hyper Text Markup Language) program, and a plurality of music piece data (sets) etc. as content to be provided to users. In response to an access request from any one of the user terminals PC, the server S returns page description information, content, etc., corresponding to the request, to the user terminal PC. Namely, in response to any of various requests (such as a request for a music piece list, request for a genre-specific music piece list, request for test-listening and request for purchase) from the user terminal PC having accessed via the communication network X, the server S delivers, to the user terminal PC, page description information for displaying a corresponding screen, music piece data, etc.

The user terminals PC are not limited to portable communication terminals, personal computer terminals, etc., and they may be any forms of equipment as along as they are capable of communicating various information with the server S via the communication terminal X and processing such various information. For example, the user terminals PC may be electronic game apparatus, electronic musical instruments, etc. Further, in the content delivery system of the present invention, a multiplicity of the user terminals PC and servers S may of course be connected via the communication terminal X.

Each of the apparatus (i.e., user terminals PC and servers S), constituting the content delivery system of the present invention, comprises an independent computer including a control unit, storage section, communication section, etc., and communication of various information is permitted between the individual apparatus via the wired or wireless communication terminal X. Because the user terminals PC and servers S may be described as using a similar hardware setup, the following description will be made representatively in relation to one user terminal PC (moiré specifically, portable phone).

As illustrated in FIG. 1, the entire user terminal PC in the embodiment of the present invention is controlled by the control unit 1 that comprises a microprocessor unit (CPU) etc. To this control unit 1 are connected, via a not-shown data and address bus, the storage section 2, input section 3, display section 4, reproduction section 5 and communication section 6. The storage section 2 comprises a ROM storing various programs and data for execution or reference by the control unit 1, and a RAM and/or memory card to be used, for example, as a working memory for temporarily storing various information and music piece data transmitted from the server S or data etc. generated as the control unit 1 executes a predetermined program and as a memory for storing a currently-executed program and data pertaining to the currently-executed program.

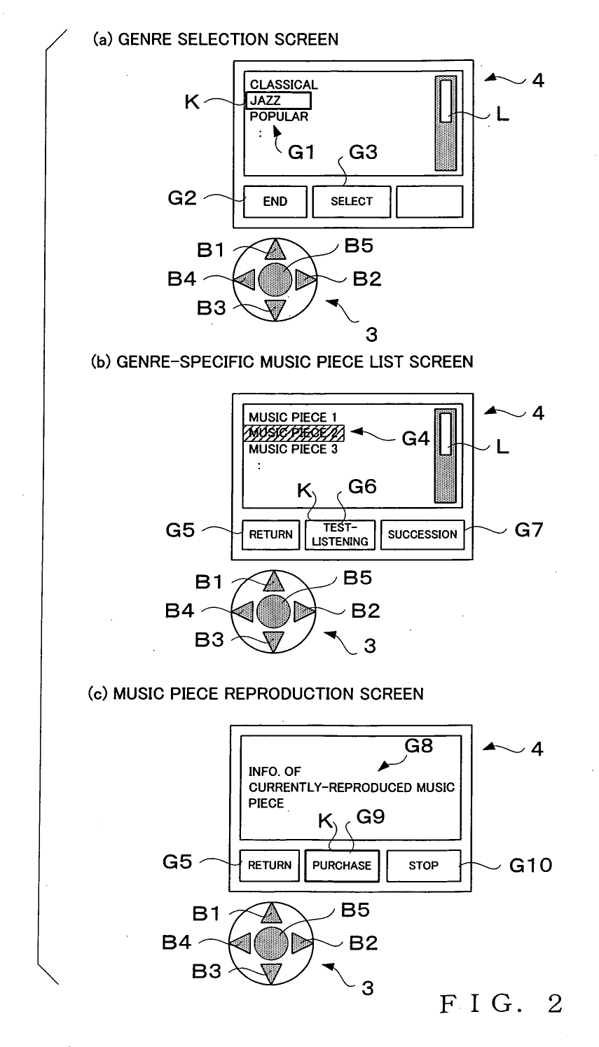

The input section 3 includes key switches for entering character data, such as a URL, and numerical value data, direction designating buttons for moving a cursor, displayed on the display section 4, in any of up-down and left-right directions, and an enter (or decision) key for deciding on a process corresponding to displayed information on a screen which the cursor is overlapping. The display section 4 is a visual display, such as a liquid crystal display (LCD), which displays various site screens, such as a later-described “genre section screen” ((a) of FIG. 2), “genre-specific music piece list screen” ((b) of FIG. 2) and “music piece reproduction screen” ((c) of FIG. 2). The reproduction section 5 is reproduction or playback equipment, including for example a tone generator for generating tones on the basis of music piece data, amplifier and speaker, and it is capable of reproducing music piece data transmitted from the server S. The communication section 6 is a communication interface which is connected to the communication network X including a LAN, internet and telephone line network. Via the communication network X, the communication section (communication interface) 6 is connected to the predetermined server S so that it can transmit requests to the server S and receive page description information for displaying site screens, music piece data, application programs for performing various processes, etc. The user terminal PC employed in the instant embodiment, for example, transmits, via the communication network X, a request for requesting the server S to download page description information, music piece data, etc. In response to such a request, the server S delivers the requested page description information, music piece data, etc. to the user terminal PC via the communication network X. Then, the user terminal PC receives, via the communication section 6, the page description information to display site screens etc., based on the received page description information, on the display section 4 (details of the technique for displaying the screens on the display section 4 are well-known and will not be described here), and store the music piece data into the storage section 2 or the like. Further, application programs for executing various processes can also be downloaded from the server S, on the basis of information entered via the user terminal PC.

The server S includes, in addition to a control unit 1′, storage section 2′ and communication section 6′, at least a sale history database (DB) and music piece database D2. The sale history database has recorded therein music pieces having so far been sold (i.e., sale performance) per user, and the music piece database D2 has recorded therein music data deliverable by the server S. Of course, these databases may be connected to the server S via the communication network X rather than being directly connected to the server S.

The above-mentioned communication section 6 (or 6′) is not limited to a wired type and may be of either or both of wired and wireless types. Further, the communication section 6 (or 6′) may include a MIDI interface for inputting tone information of the MIDI standard (i.e., MIDI data) from external MIDI equipment or the like to the user terminal PC and outputting tone information of the MIDI standard (i.e., MIDI data) from the user terminal PC to external MIDI equipment or the like.

Generally, content delivery systems using wireless communication facilities are arranged as “download-assured systems” which permit a user to re-download purchased content free of charge as many times as desired within a predetermined time period (e.g., one-month time period) from the date of the purchase so that the content can be reliably loaded into a portable phone or the like. Such systems are publicly known today and thus will not be explained here in detail.

The user terminal PC may be provided with an external storage device, such as a hard disk device, for storing page description information, music piece data, etc. received from the server S or application programs etc. to be executed by the control unit 1. The external storage device may of course be one using any of removable external storage media, other than a hard disk, such as a flexible disk (FD), compact disk (CD), magneto-optical disk (MO) and digital versatile disk (DVD). Alternatively, the external storage device may comprise a semiconductor memory. Note that the user terminal PC is not limited to the type where the input section 3, reproduction section 5, etc. are incorporated together in the body of the apparatus PC, and the user terminal PC may be of a type where the input section 3, reproduction section 5, etc. are provided separately and connected together via predetermined interfaces; the same can be said for the server S.

Next, with reference to FIG. 2, a description will be given about constructions of site screens presented by the server S to the user terminal PC, i.e. screens to be displayed on the display section 4 of the user terminal PC on the basis of page description information, as well as example manners in which these site screens are operated. As shown in (a)-(c) of FIG. 2, the input section 3 is provided below the display section 4 displaying various screens, and the input section 3 includes four direction designating buttons (“up” and “down” , and “left” and “right” buttons) B1-B4 and a decision (or enter) button B5 surrounded by the four direction designating buttons B1-B4. With the decision button, movement (and scroll display responsive to the movement) of a cursor displayed on each of the screens and process can be decided on.

(a) of FIG. 2 is a conceptual diagram showing an example of the “genre selection screen”, which is displayed, for example, in response to a music-piece-list request issued in response to test-listening-service selection operation performed by the user on a top screen (not shown) of a service site that provides an accessed data delivery service, or in response to user's operation of a “return” button G5 on the “genre-specific music piece list screen” (to be later described in relation to (b) of FIG. 2). On the “genre selection screen”, there are displayed a genre list G, “end” button G2 and “select” button G3. The genre list G indicates a list of music genres, such as classical, jazz and popular, so that the user can select any one of the genres to which a user-desired music piece appears to belong (or appears to be classified). Namely, the user operates the vertical direction designating button B1 or B3 to vertically move the cursor K (indicated by a small thick-line rectangular block) so as to overlap a desired genre—alternatively, the user can directly designate a number assigned to the desired genre to thereby cause the cursor K to jump to the desired genre—. Then, once the user operates the decision button B5, the cursor K is fixed at the desired genre and highlighted as indicated by a hatched block in (b) of FIG. 2. If, at that time, the genre list contains too many genres so that the entire page showing the entire genre list can not be displayed concurrently on the screen, the screen is scrolled by the user operating the vertical direction designating button B1 or B3. Scrollbar L displayed on a right end region of the screen is also moved in the up-down direction in accordance with the scroll operation, and, on the basis of the displayed position of the scrollbar L, the user can readily identify an approximate position in the genre-list-showing page where the currently-displayed screen is located. Following the operation of the decision button B5, the cursor K automatically moves to the select button G3. Then, once the decision button B5 is again operated with the cursor K on the select button G3, the desired genre is selected, and the display shifts to the “genre-specific music piece list screen”. If the user operates the horizontal direction designating button B2 or B4 to move the cursor K from the select button 3 to the end button G2 and then operates the decision button B5, the “genre selection screen” is terminated, and the display returns to the not-shown top screen.

(b) of FIG. 2 is a conceptual diagram showing an example of the “genre-specific music piece list screen”, which is displayed, for example, in response to a genre-specific-list request issued by user's operation of the select button G3 on the “genre selection screen”, or in response to user's operation of the return button G5 on the “music piece reproduction screen” (to be later described in relation to (c) of FIG. 2). On the “genre-specific music piece list screen”, there are displayed the music piece list G4, return button G5, “test-listen” button G6, “succession” (successive test-listen) button G7. The list of music piecesG4 indicates a list of titles etc. of all music pieces included in the selected genre, from which the user can selected a desired music piece. As in the genre selection, the user operates the vertical direction designating button B1 or B3 to vertically move the cursor K along with a scroll display and then operates the decision button B5, so that the cursor K is fixed at a desired music piece and highlighted as indicated by the hatched block in (b) of FIG. 2. In this case, after the operation of the decision button B5, the cursor K automatically shifts to the test-listen button G6 (as indicated by a thick-line block), and once the decision button B5 is again operated with the cursor K on the test-listen button G6, the desired music piece is selected, the display shifts to the “music piece reproduction screen”, and then test-listening of the desired music piece is started. Then, if the user operates the horizontal direction designating button B2 or B4 to move the cursor K from the test-listen button G6 to the succession button G7 and then again operates the return button G5, the display shifts to the “music piece reproduction screen”, and sequential test-listening reproduction all of the music pieces, included in the selected genre, is started beginning with the leading music piece in the list. If the user operates the horizontal direction designating button B2 or B4 to move the cursor K from the test-listen button G6 to the return button G5 and then again operates the decision button B5, the “genre-specific music piece list screen” is ended, and the display returns to the “genre selection screen”.

(c) of FIG. 2 is a conceptual diagram showing an example of the “music piece reproduction screen”, which is displayed, for example, in response to a test-listening request issued by user's operation of the test-listen button G6 or succession button G7 on the “genre-specific music piece list screen” On the “music piece reproduction screen”, there are displayed information of a currently-reproduced music piece G8, return button G5, “purchase” button G9 and “stop” button G10. The information of the currently-reproduced music piece G8 includes, for example, information indicative of the title of the currently-reproduced music piece, artist, lyrics, lyricist/composer, playing time, etc. On the “music piece reproduction screen”, each tone being reproduced can be increased or decreased in tone volume in response to operation of the vertical direction designating button B1 or B3. Further, the cursor K can be moved to any desired one of the return button G5, purchase button G9 and stop button G10 as indicated by a thick-line block. If the decision button B5 has been operated with the cursor K on the purchase button G9, the currently-reproduced music piece is downloaded upon completion of the reproduction. If the decision button B5 has been operated with the cursor K on the stop button G10, the reproduction of the music piece is immediately terminated. If one of the horizontal direction designating buttons (rightward-direction designating button B2 or leftward-direction designating button B4) has been operated, reproduction of another music piece immediately following the currently-reproduced music piece or reproduction-terminated music piece is started. But, if the other of the horizontal direction designating buttons (leftward-direction designating button B4 or rightward-direction designating button B2), reproduction of the currently-reproduced music piece or reproduction-terminated music piece is started from the beginning. However, if the leftward-direction designating button B4 or rightward-direction designating button B2 is double-clicked, reproduction of another music piece immediately preceding the currently-reproduced music piece or reproduction-terminated music piece is started, instead of reproduction of the currently-reproduced music piece or reproduction-terminated music piece being started. In the case where reproduction the preceding music piece has been instructed during reproduction of an nth music piece (i.e., if returning to a (n−1)th music piece has been instructed during reproduction of the nth music piece), music piece data of an (n−2)th music piece are again acquired. If the decision button B5 has been operated after the cursor K is moved to the end button G2, the “music piece reproduction screen” and tone generation are terminated, and the display returns to the “genre-specific music piece list screen”.

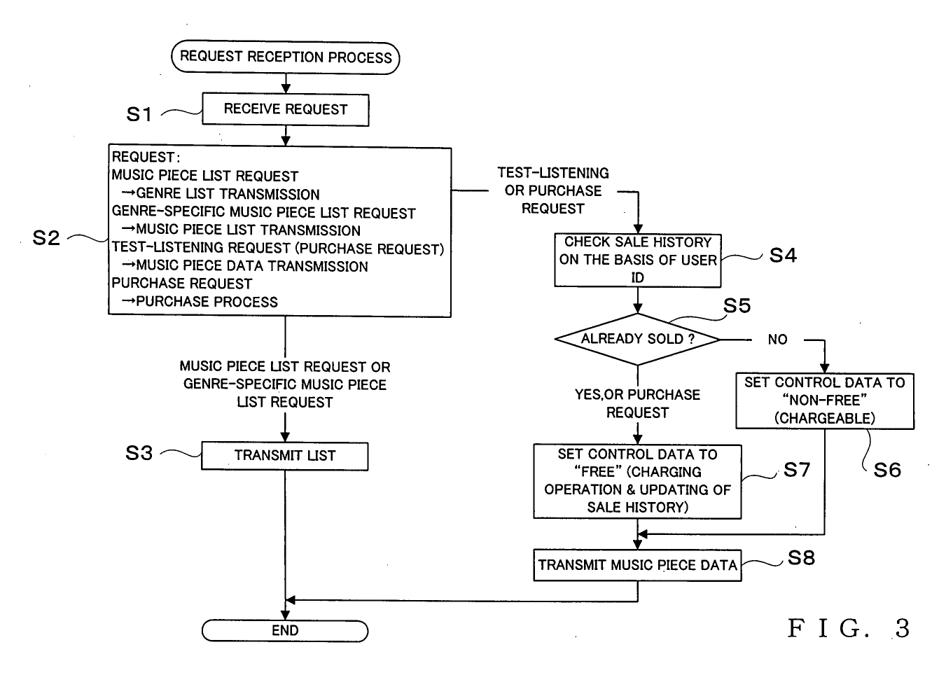

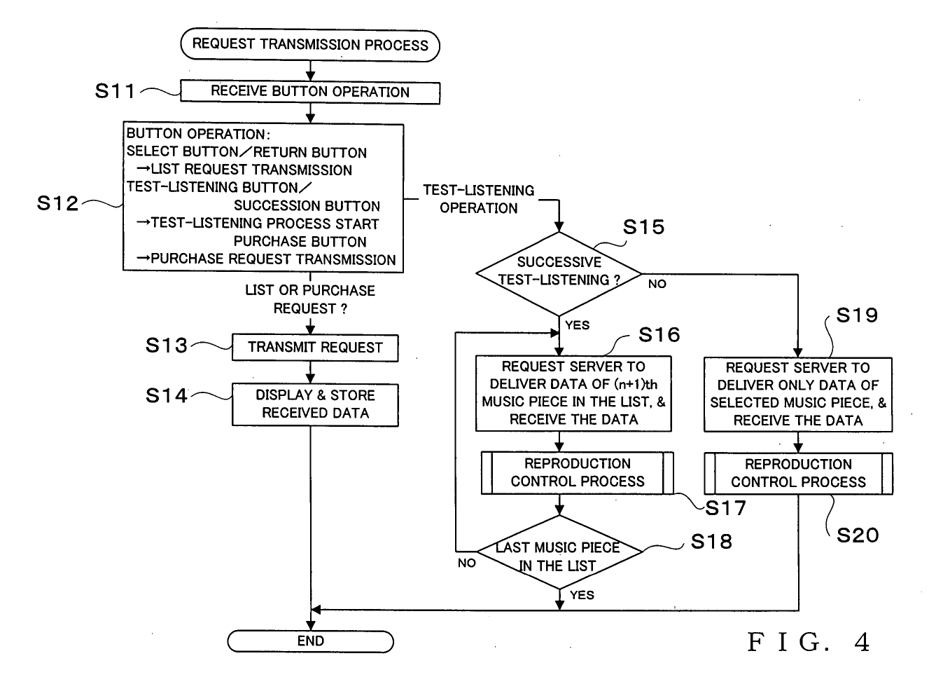

In order for the user to receive the data delivery service, the user has to appropriately access the server S providing the data delivery service and then ask for or request test-listening or purchase of a desired music piece in accordance with various sequentially-displayed site screens (e.g., the above-mentioned genre selection screen, genre-specific music piece list screen, tone reproduction screen and the like). Therefore, the following paragraphs describe a “request receipt process” performed in the server S (FIG. 3) and a “request transmission process” performed in the user terminal PC (FIG. 4). FIG. 3 is a flow chart showing an example operational sequence of the “request receipt process” performed in the server S, and FIG. 4 is a flow chart showing an example operational sequence of the “request transmission process” performed in the user terminal PC. These processes are programs started up as necessary in the server S and user terminal PC, and the server S and user terminal PC are each constantly placed in a request awaiting state or operation awaiting state after the startup of the request receipt process or request transmission process. The request receipt process is started in response to receipt of any request from the user terminal PC, while the request transmission process is started in response to user's operation of any one of the button G2-G4 displayed on the screens.

First, the “request receipt process” performed in the server S is described with reference to the flow chart of FIG. 3. At step S1, the server S receives a request transmitted from the user terminal PC connected to the server S via the communication network X. The request transmitted from the user terminal PC is any one of, for example, the music piece list request issued in response to test-listening selection operation on the top screen of the service site or the like, genre-specific music piece list request issued in response to operation of the select button G3 (see (a) of FIG. 2) on the “genre selection screen”, test-listening request issued in response to operation of the test-listen button G6 or succession button G7 (see (b) of FIG. 2) on the “genre-specific music piece list” and purchase request issued in response to operation of the purchase button G9 (see (c) of FIG. 2) on the “music piece reproduction screen”. Once the server S in the request-awaiting state receives such a request from the user terminal PC, predetermined control is assigned to perform operations corresponding to the received request (step S2).

If the received request is the music piece list or genre-specific music piece list request, page description information for displaying a list corresponding to the request (the page description information may include related text data and image data, etc.) is returned to the user terminal PC (step S3). Namely, the genre selection screen-shown in (a) of FIG. 2 or the “genre-specific music piece list” shown in (b) of FIG. 2 is presented to the user terminal PC. Further, if the received request is a test-listening request or purchase request, the server S refers to the sale history database D1 on the basis of the unique user ID assigned in advance to the user of the user terminal PC, to thereby check the sale history of the user having made the request concerning the music piece selected as an object of test-listening or purchase (step S4). As the sale history check, the server S determines, at step S5, whether or not the music piece currently selected as an object of test-listening or purchase is a music piece already purchased by the user before the request (i.e., already sold to the user by the server S). If it has been determined that the received request is a test-listening request and the music piece currently selected as an object of test-listening is a music piece already purchased by the user (i.e., already sold to the user by the server S), predetermined control data is set to a value “0” indicating “free” (i.e., free of charge). Further, only if the received request is a purchase request, the server S carries out a billing operation for causing the user to pay a charge preset for the music piece in question (i.e., one of charges preset for individual deliverable music pieces), and then updates the sale history database D1 so that the music piece is recorded as “already purchased” (step S7). If it has been determined that the received request is a test-listening request and the music piece currently selected as an object of test-listening is a music piece not yet purchased by the user (i.e., not yet sold to the user by the server S) (“no sale record” at step S5), the predetermined control data is set to a value “1” indicating “non-free” (i.e., chargeable) (step S6).

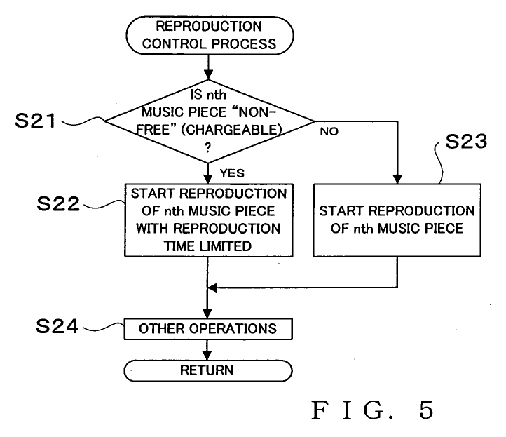

At step S8, music data of the music piece currently selected as an object of test-listening or purchase is searched through the music piece database D2, and the thus-found music piece data is transmitted to the user terminal PC. The above-mentioned control data is data used as a parameter for performing control as to whether the music piece in question should be reproduced in a later-described “reproduction control process” (see FIG. 5) with the reproduction time limited (e.g., when the control data is set at “1” indicating “non-free” (i.e., charged)) or the music piece should be reproduced in its entirety (full reproduction) without the reproduction time limited (e.g., when the control data is set at “0” indicating “free”). This control data is attached to the music piece data (it may be embedded in the music piece data or associated with the music piece data in any other manner), and transmitted to the user terminal PC along with the music piece data. Of course, the control data may be other than the above-mentioned flag (“0” indicating “free”, or “1” indicating “non-free”), such as a number of points added in accordance with user's usage of the data delivery service (e.g., a number of points equal to or greater than a predetermined value may indicate “free”, or a number of points smaller than the predetermined value may indicate “non-free”), or a predetermined “non-free” or “free” mark. Referring back to the flow chart of FIG. 3, the server S reverts to the request awaiting state after transmission, at step S8, of the music piece data so as to wait the operations until a new request is received (step S1). Namely, the server S waits until another request is received from any one of the user terminals PC connected thereto via the communication network X. Upon receipt of such a request, the server S transmits information pertaining to screens to be displayed, user-desired music piece data, etc., corresponding to the request, to the user terminal PC having issued the request.

Next, the “request transmission process” performed in the user terminal PC will be described, with reference to the flow chart of FIG. 4, in relation to a case where an nth (initially, 0th) music piece in the music piece list has been selected as an object of reproduction and music piece data of up to three music pieces (preceding (i.e., (n−1)th) music piece, currently-reproduced (i.e., nth) music piece and following (i.e., (n+1)th) music piece) are retained in the RAM. Namely, this “request transmission process” is arranged to permit smooth successive reproduction by thus pre-reading and prestoring not only the currently-reproduced music piece but also the preceding and following music pieces.

At step S11, the user terminal PC receives operation of any one of the buttons of a screen displayed on the display section 4. Examples of the buttons on the displayed screen include the select button G3 on the “genre selection screen” (see (a) of FIG. 2), the return button G5 on the “genre-specific music piece list screen” or “music piece reproduction screen” selection screen” (see (b) or (c) of FIG. 2), the test-listen button G6 or succession button G7 on the “genre-specific music piece list screen” (see (b) of FIG. 2), the purchase button G9 on the “music piece reproduction screen” (see (c) of FIG. 2), etc. At next step S12, control is assigned to perform operations corresponding to the received operation. If the received operation is operation of the select button G3, return button G5 or purchase button (list request or purchase request at step S12), the user terminal PC transmits, to the server S it is accessing via the communication network X, a music-piece-list request or genre-specific music piece list if the received operation is operation of the select button G3 or return button G5 or a purchase request if the received operation is operation of the purchase button (step S13); at that time, the user ID is also transmitted. At step S14, data received from the server S in response to the transmitted request, is displayed or stored. More specifically, when page description information has been received from the server S in response to the transmitted list request, the received page description information is stored into the RAM, and each corresponding screen is displayed on display section 4 on the basis of the page description information. When music piece data has been received from the server S in response to the transmitted purchase request, the received music piece data is stored into the data library region of the RAM or memory card.

If the received operation is operation of the test-listen button or succession button (test-listening operation at step S12), a determination is made, at step S15, as to whether the received operation is operation of the succession button that instructs successive test-listening. With a YES determination at step S15, the user terminal PC transmits a test-listening request for requesting the server S to deliver the music piece data of the (n+1)th music piece in the genre-specific music piece list, and then receives the requested music piece data from the server S (step S16). Namely, in the instant embodiment, the genre-specific music piece list received from the server S is used as a list of music pieces to be test-listened to. At step S17, the “reproduction control process” is performed for generating tones on the basis of the music piece data delivered from the server S, as will be later described in detail with reference to FIG. 5. At following step S18, a determination is made as to whether or not the test-listening has progressed to the last of the genre-specific music piece list. With a YES determination at step S18, the instant process is brought to an end. If, on the other hand, the test-listening has not yet progressed to the last of the genre-specific music piece list (NO determination at step S18), “1” is added to “n” in order to make the next music piece an object of test-listening, and then the user terminal PC reverts to step S16 to repeat the above-described operations. Although not specifically shown here, if the return button G5 on the “music piece reproduction screen” (see (c) of FIG. 2) has been operated, the instant process may be either terminated even when the current reproduced position is partway through the list, or may be continued as before. If it has been determined, at step S15, that the received operation is not one instructing successive test-listening (NO determination at step S15), the user terminal PC transmits a test-listening request for requesting the server S to deliver music piece data of only one music piece selected as an object of test-listening (step S19). At step S20, the “reproduction control process” is carried out (see FIG. 5) to reproduce the received music piece data. Namely, if the received operation is not one instructing successive operation, what is reproduced is only one selected music piece.

Now, with reference to FIG. 5, a description will be given about the “reproduction control process” (see step S17 or S20 of FIG. 4) carried out in the “request transmission process” shown in FIG. 4. FIG. 5 is a flow chart showing an example operational sequence of the “reproduction control process”. At step S21, a determination is made as to whether the nth music piece (in the case of successive test-listening) or one selected music piece (in the case of non-successive test-listening), received in response to the test-listening request, is “non-free” or “free”. The determination at step S21 is made with reference to the predetermined control data attached to the music piece data. With a YES determination at step S21, reproduction of the received music piece data is started with the reproduction time limited, at step S22. If, on the other hand, it has been determined that the nth music piece or selected one music piece is “free” (NO determination at step S21), reproduction of the received music piece data is started without the reproduction time limited, at step S23. At step S24, other operations are carried out; the other operations carried out here include operations pertaining to reproduction control, such as tone volume control, control to return the reproduced position to the beginning of the music piece, control to perform the following or preceding music piece or control to pause/resume the performance, and the like. In the instant embodiment, music piece data of each music piece, of which the control data is set at “free” as an attribute of the music piece, is copied/stored into the data library region of the RAM or memory card (or other suitable storage medium) so that it can be set as a ringer melody or reproduced as necessary via a built-in music player. On the other hand, music piece data of each music piece, of which the control data is set at “non-free” as an attribute of the music piece, is temporarily retained in the working area of the RAM until a performance of the next music piece is brought to an end (if the requested reproduction is successive test-listening), and it is then entirely deleted when the retained music piece data has been reproduced or upon termination of the application program. As one example of the reproducing limitation of a “non-free” (i.e., chargeable) music piece, reproduction of the music piece is permitted only for 45 sec. from the beginning of the music piece data and then compulsorily terminated upon lapse of 45 sec.; however, the reproducing limitation may of course be other than such a limitation on the reproducing time.

The above-described arrangements are very convenient in that each interested user can test-listen to a plurality of music pieces without making a test-listening request per music piece. Further, during music piece test-listening, music piece data with the reproducing limitation (i.e., “free” “non-free” setting by the control data) lifted therefrom (or regular music piece data rather than test-listening or trial-use (sample) music piece data) is supplied for each already-purchased music piece, the above-described arrangements can reliably prevent impairment of the right of each user having duly purchased the music piece, but also allows each user to readily distinguish, during test-listening, between each already-purchased music piece and each not-yet-purchased music piece, so that the user can readily purchase a desired music piece as necessary at the time of test-listening. Information as to whether content currently being reproduced for test-listening is non-free or chargeable (i.e. not-yet-purchased) or free (already-purchases) may be visually or aurally displayed to the user on the basis of the above-mentioned control data.

The server S may prestore, per music piece, two different kinds of music piece data corresponding respectively to a test-listening request and purchase request, instead of prestoring (and hence delivering) a same kind of music piece data for each of the test-listening request and purchase request. For example, there may be prestored, per music piece, test-listening music piece data (with a lowered bit rate and/or limited reproducing time) to be delivered in response to a test-listening request, and regular music piece data (with no limitation like that placed or set on the test-listening, trial-use (sample) music piece data) to be delivered in response to a purchase request. In this case, even when the received request is a test-listening request, the server S transmits the regular music piece data if it has been determined, by reference to the sales history database D1, that the requested music piece is a music piece already purchased (and hence free of charge).

At the time of the successive test-listening, the server S may permit successive test-listening of only a music piece designated by a user (e.g., through designation with the cursor) from a music piece list and then following music piece(s) in the list, instead of successive test-listening starting with the beginning of the music piece list. Alternatively, the server S permits successive test-listening of only a plurality of user-designated music pieces.

Whereas the embodiment has been described above in relation to the case where music piece data are provided as content, the present invention is not so limited, and content to be provided may be animation data, voice data, text data and other data that can be delivered via the communication network X. In such a case, some of the content is not visible content to be viewed or read rather than audible content, and thus, the terms “test-listening” used in the above description of the embodiment should be construed more broadly as “trial use”.

Further, whereas the embodiment has been described above in relation to the case where each desired music piece is selected from the “genre-specific screen” having music pieces classified therein according to genres, the present invention is not so limited, and each desired music piece may be selected from a screen having music pieces classified therein according to, for example, artists, Japanese or English alphabetical letters. Alternatively, each desired music piece may be selected from a list of music pieces extracted through keyword search or the like.

The above-mentioned processes are implemented by predetermined software programs executed by the control sections of the individual apparatus. Of course, the above-mentioned processes may be implemented by microprograms to be executed by a DSP (Digital Signal Processor), rather than by the computer software programs. Alternatively, the processes may be performed by a dedicated hardware apparatus that includes discrete circuits, integrated and/or large-scale integrated circuitry or gate arrays, rather than by the above-mentioned programs.

Further, the content-providing server S may be in the form of a plurality of server computers liked together in the communication network (or server computers residing in a plurality of locations). Alternatively, a particular device (such as a content storage device (database)) for the content-providing server may be provided in a position remote from the server compute and linked with the server computer in the communication network.

What is claimed is:

1. A content delivery system for communicating content between a content reproduction apparatus and a content-providing server interconnected via a communication network,
said content reproduction apparatus comprising:
a section that connects said content reproduction apparatus to the content-providing server for communication therewith via the communication network;
a section that receives a list of trial-use content from the content-providing server;
a section that, on the basis of the list, makes a request for requesting the content-providing server to successively deliver a plurality of trial-use content;
a reception section that receives, from the content-providing server, the plurality of trial-use content, sequentially delivered by the content-providing server in response to the request, with or without a reproducing limitation set on each of the content; and
a reproduction section that reproduces the content, received by said reception section, with or without a limitation depending on presence/absence of the reproducing limitation set on the content,
said content-providing server comprising:
a section that connects said content-providing server to the content reproduction apparatus for communication therewith via the communication network;
a content storage section that stores a plurality of content;
a sale history storage section that stores a sale history of each of the content stored in said content storage section, the sale history indicating a history of a sale of the content made to a user of the content reproduction apparatus;
a section that supplies a list of trial-use content to the content reproduction apparatus;
a readout section that, in response to a request for successive delivery of two or more trial-use content issued by the content reproduction apparatus on the basis of the list, sequentially reads out corresponding content from said content storage section;
a section that makes a determination as to whether a reproducing limitation should be set on the content read out by said readout section, on the basis of the sale history stored in said sale history storage section for a sale, to the user of the content reproduction apparatus, of the read-out content; and
a section that, in accordance with a result of the determination, delivers the read-out content to the content reproduction apparatus with or without a reproducing limitation.

2. A content delivery system as claimed in claim 1 wherein, when the content is to be delivered, said content-providing server attaches, to the content, control data indicating either a setting “with a reproducing limitation” or a setting “with no reproducing limitation”, and delivers, to the content reproduction apparatus, the content with the control data attached thereto, and
wherein said content reproduction apparatus reproduces the content with or without a reproducing limitation depending on whether the control data attached to the content received by said reception section indicates the setting “with a reproducing limitation” or the setting “with no reproducing limitation”.

3. A content delivery system as claimed in claim 2 wherein said content reproduction apparatus further comprises a section that performs control to cause the content to be reproduced for trial use on a chargeable or free-of-charge basis depending on whether the control data attached to the received content indicates the setting “with a reproducing limitation” or the setting “with no reproducing limitation”.

4. A content delivery system as claimed in claim 1 wherein said content-providing server processes content to be delivered with a reproducing limitation in such a manner that the content itself has only limited reproducibility and then delivers resultant processed content, and
wherein, when the content received by said reception section itself has only limited reproducibility, said content reproduction apparatus reproduces the received content with a reproducing limitation set thereon.

5. A content delivery system as claimed in claim 1 wherein said content reproduction apparatus further comprises: a section that transmits, to said content-providing server, a purchase request for purchasing the content being reproduced by said reproduction section; and a section that receives and stores content delivered by said content-providing server in response to the purchase request, and
wherein said content-providing server further comprises: a section that, in response to the purchase request transmitted by said content reproduction apparatus, reads out the content from said content storage section and transmits the read-out content, as sold content, to said content reproduction apparatus with no reproducing limitation; and a section that updates the sale history stored in said sale history storage section for the sold content.

6. A content delivery system as claimed in claim 1 wherein the content is audible content, and trial reproduction performed by said content reproduction apparatus is reproduction for test-listening.

7. A content reproduction apparatus comprising:
a section that connects said content reproduction apparatus to a content-providing server for communication therewith via a communication network;
a section that receives a list of trial-use content from the content-providing server;
a section that, on the basis of the list, makes a request for requesting the content-providing server to successively deliver a plurality of trial-use content;
a reception section that receives, from the content-providing server, the plurality of trial-use content, sequentially delivered by the content-providing server in response to the request, with or without a reproducing limitation set on each of the content; and
a reproduction section that reproduces the content, received by said reception section, with or without a limitation depending on presence/absence of the reproducing limitation set on the content.

8. A content reproduction apparatus as claimed in claim 7 wherein each of the plurality of trial-use content, delivered by the content-providing server, has attached thereto control data indicating either a setting “with a reproducing limitation” or a setting “with no reproducing limitation”, and
wherein said reproduction section reproduces each of the content with or without a reproducing limitation depending on whether the control data attached thereto indicates the setting “with a reproducing limitation” or the setting “with no reproducing limitation”.

9. A content reproduction apparatus as claimed in claim 7 which further comprises: a section that transmits, to the content-providing server, a purchase request for purchasing the content being reproduced by said reproduction section; and a section that receives and stores content delivered by the content-providing server in response to the purchase request.

10. A content-providing server comprising:
a section that connects said content-providing server to a content reproduction apparatus for communication therewith via a communication network;
a content storage section that stores a plurality of content;
a sale history storage section that stores a sale history of each of the content stored in said content storage section, the sale history indicating a history of a sale of the content made to a user of the content reproduction apparatus;
a section that supplies a list of trial-use content to the content reproduction apparatus;
a readout section that, in response to a request for successive delivery of two or more trial-use content issued by the content reproduction apparatus on the basis of the list, sequentially reads out corresponding content from said content storage section;
a section that makes a determination as to whether a reproducing limitation should be set on the content read out by said readout section, on the basis of the sale history stored in said sale history storage section for a sale, to the user of the content reproduction apparatus, of the read-out content; and
a delivery section that, in accordance with a result of the determination, delivers the read-out content to the content reproduction apparatus with or without a reproducing limitation.

11. A content-providing server as claimed in claim 10 wherein said delivery section attaches, to the content read out by said readout section, control data indicating either a setting “with a reproducing limitation” or a setting “with no reproducing limitation”, delivers, to the content reproduction apparatus, the content with the control data attached thereto.

12. A content-providing server as claimed in claim 10 which further comprises: a section that, in response to a purchase request transmitted by the content reproduction apparatus, reads out the content from said content storage section and transmits the read-out content, as sold content, to the content reproduction apparatus with no reproducing limitation; and a section that updates the sale history stored in said sale history storage section for the sold content.

13. A content delivery method for communicating content between a content reproduction apparatus and a content-providing server interconnected via a communication network,
said content delivery method performing in said content reproduction apparatus:
a step of receiving a list of trial-use content from the content-providing server;
a step of, on the basis of the list, making a request for requesting the content-providing server to successively deliver a plurality of trial-use content;
a reception step of receiving, from the content-providing server, the plurality of trial-use content, sequentially delivered by the content-providing server in response to the request, with or without a reproducing limitation set on each of the content; and
a reproduction step of reproducing the content, received by said reception step, with or without a limitation depending on presence/absence of the reproducing limitation set on the content,
said content delivery method performing in said content-providing server:
a step of supplying a list of trial-use content to the content reproduction apparatus;
a readout step of, in response to a request for successive delivery of two or more trial-use content issued by the content reproduction apparatus on the basis of the list, sequentially reading out corresponding content from a content storage section;
a step of making a determination as to whether a reproducing limitation should be set on the content read out by said readout step, on the basis of a sale history stored in a sale history storage section for a sale, to a user of the content reproduction apparatus, of the read-out content; and
a step of, in accordance with the a result of determination, delivering the read-out content to the content reproduction apparatus with or without a reproducing limitation.

14. A content delivery method as claimed in claim 13 wherein, when the content is to be delivered, the content-providing server attaches, to the content, control data indicating either a setting “with a reproducing limitation” or a setting “with no reproducing limitation”, and delivers, to the content reproduction apparatus, the content with the control data attached thereto, and
wherein the content reproduction apparatus reproduces the content with or without a reproducing limitation depending on whether the control data attached to the content received by said reception step indicates the setting “with a reproducing limitation” or the setting “with no reproducing limitation”.

15. A content delivery method as claimed in claim 13 which further performs in the content reproduction apparatus: a step of transmitting, to the content-providing server, a purchase request for purchasing the content being reproduced by said reproduction step; and a step of receiving and storing the content delivered by the content-providing server in response to the purchase request, and
which further performs in the content-providing server: a step of, in response to the purchase request transmitted by the content reproduction apparatus, reading out the content from the content storage section and transmitting the read-out content, as sold content, to the content reproduction apparatus with no reproducing limitation; and a step of updating the sale history stored in the sale history storage section for the sold content.

16. A content reproduction method performed in a content reproduction apparatus that connects with a content-providing server for communication therewith via a communication network, said content reproduction method comprising:
a step of receiving a list of trial-use content from the content-providing server;
a step of, on the basis of the list, making a request for requesting the content-providing server to successively deliver a plurality of trial-use content;
a reception step of receiving, from the content-providing server, the plurality of trial-use content, sequentially delivered by the content-providing server in response to the request, with or without a reproducing limitation set on each of the content; and
a reproduction step of reproducing the content, received by said reception step, with or without a limitation depending on presence/absence of the reproducing limitation set on the content.

17. A content reproduction method as claimed in claim 16 which further comprises: a step of transmitting, to the content-providing server, a purchase request for purchasing the content being reproduced by said reproduction step; and a step of receiving and storing content delivered by the content-providing server in response to the purchase request.

18. A content-providing method performed in a content-providing server that connects with a content reproduction apparatus for communication therewith via a communication network, the content-providing server including: a content storage section that stores a plurality of content; and a sale history storage section that stores a sale history of each of the content stored in said content storage section, the sale history indicating a history of a sale of the content made to a user of the content reproduction apparatus, said content-providing method comprising:
a step of supplying a list of trial-use content to the content reproduction apparatus;
a readout step of, in response to a request for successive delivery of two or more trial-use content issued by the content reproduction apparatus on the basis of the list, sequentially reading out corresponding content from the content storage section;
a step of making a determination as to whether a reproducing limitation should be set on the content read out by said readout step, on the basis of the sale history stored in the sale history storage section for a sale, to the user of the content reproduction apparatus, of the read-out content; and
a delivery step of, in accordance with a result of the determination, delivering the read-out content to the content reproduction apparatus with or without a reproducing limitation.

19. A content-providing method as claimed in claim 18 which further comprises: a step of, in response to a purchase request transmitted by the content reproduction apparatus, reading out the content from the content storage section and transmitting the read-out content, as sold content, to the content reproduction apparatus with no reproducing limitation; and a step of updating the sale history stored in the sale history storage section for the sold content.

20. A program containing a group of instructions for causing a computer, provided in a content reproduction apparatus that connects with a content-providing server for communication therewith via a communication network, to perform a content reproduction procedure, said content reproduction procedure comprising:
a step of receiving a list of trial-use content from the content-providing server;
a step of, on the basis of the list, making a request for requesting the content-providing server to successively deliver a plurality of trial-use content;
a reception step of receiving, from the content-providing server, the plurality of trial-use content, sequentially delivered by the content-providing server in response to the request, with or without a reproducing limitation set on each of the content; and
a reproduction step of reproducing the content, received by said reception step, with or without a limitation depending on presence/absence of the reproducing limitation set on the content.

21. A program containing a group of instructions for causing a computer, provided in a content-providing server that connects with a content reproduction apparatus for communication therewith via a communication network, to perform a content providing procedure, the content-providing server including: a content storage section that stores a plurality of content; and a sale history storage section that stores a sale history of each of the content stored in said content storage section, the sale history indicating a history of a sale of the content made to a user of the content reproduction apparatus, said content-providing procedure comprising:
a step of supplying a list of trial-use content to the content reproduction apparatus;
a readout step of, in response to a request for successive delivery of two or more trial-use content issued by the content reproduction apparatus on the basis of the list, sequentially reading out corresponding content from the content storage section;
a step of making a determination as to whether a reproducing limitation should be set on the content read out by said readout step, on the basis of the sale history stored in the sale history storage section for a sale, to the user of the content reproduction apparatus, of the read-out content; and
a delivery step of, in accordance with a result of the determination, delivering the read-out content to the content reproduction apparatus with or without a reproducing limitation.
